(19) United States
(12) Patent Application Publication
(10) Pub. No.: US 2018/0284463 A1
(43) Pub. Date: Oct. 4, 2018

(54) MULTI-OPTICAL ADJUSTABLE SHOOTING SYSTEM

(71) Applicant: UNION OPTECH CO., LTD., Zhongshan (CN)

(72) Inventor: Junqiang Gong, Zhongshan (CN)

(21) Appl. No.: 15/719,602

(22) Filed: Sep. 29, 2017

(30) Foreign Application Priority Data
Mar. 29, 2017 (CN) 201710197322.3

(51) Int. Cl. G02B 27/10; H04N 9/097

(52) U.S. Cl. CPC G02B 27/1013; H04N 9/097

(57) ABSTRACT

The present invention discloses a multi-optical adjustable shooting system, including an optical lens, where a spectroscopical module that can split a light wave transmitted from the optical lens into several light waves in different wavelength ranges is disposed on an imaging side of the optical lens; the shooting system further includes an optical path adjustment mechanism configured to adjust an optical path and a photosensitive chip configured to receive a light signal; the shooting system further includes an image processing system that can integrate and output light waves received by various photosensitive chips; and the optical path adjustment mechanism is disposed between the spectroscopical module and the photosensitive chip. In the present invention, high definition of a shot image is implemented, image color restoration is good, and clear imaging can be implemented even in low illuminancy.

### CROSS REFERENCE TO RELATED APPLICATIONS

The present application claims the benefit of Chinese Patent Application No. 201710197322.3 filed on Mar. 29, 2017. All the above are hereby incorporated by reference.

### BACKGROUND

### Technical Field

The present invention relates to an optical system, and in particular, to a multi-optical adjustable shooting system.

### Related Art

Currently, a monitoring shooting system is widely applied to people's daily life. However, a current security monitoring system and road condition system have the following disadvantages:

1. In an existing shooting system, a manner of matching a single lens with a single photosensitive chip is used, and for the single photosensitive chip, a light wave wavelength that needs to be received is relatively wide, therefore causing overall picture definition to be not high, and a shooting effect of the entire picture to be not good.

2. In an existing shooting system, a manner of matching a single lens with a single photosensitive chip is used, and wavelengths reflecting various colors are not well restored in the single photosensitive chip, therefore causing a phenomenon of the color of a shot picture being not full.

3. In an existing shooting system, a manner of matching a single lens with a single photosensitive chip is used, and in a low illuminancy environment, wavelengths of some light waves cannot be utilized, causing an amount of overall passed light to decrease, and a shot image to be unclear.

Therefore, the present invention emerges based on the foregoing disadvantages.

### SUMMARY

A technical problem that needs to be resolved by the present invention is to provide a multi-optical adjustable shooting system. In the system, high definition of a shot image is implemented, image color restoration is good, and clear imaging can be implemented even in low illuminancy.

To resolve the foregoing technical problem, the following technical solution is used in the present invention: a multi-optical adjustable shooting system, including an optical lens, where a spectroscopical module that can split a light wave transmitted from the optical lens into several light waves in different wavelength ranges is disposed on an imaging side of the optical lens; the shooting system further includes an optical path adjustment mechanism configured to adjust an optical path and a photosensitive chip configured to receive a light signal; the shooting system further includes an image processing system that can integrate and output light waves received by various photosensitive chips; and the optical path adjustment mechanism is disposed between the spectroscopical module and the photosensitive chip.

In the multi-optical adjustable shooting system described in the foregoing, the spectroscopical module includes at least one spectroscopical component.

In the multi-optical adjustable shooting system described in the foregoing, the shooting system includes at least one spectroscopical module.

In the multi-optical adjustable shooting system described in the foregoing, the shooting system includes at least two photosensitive chips.

In the multi-optical adjustable shooting system described in the foregoing, the shooting system includes two spectroscopical modules.

In the multi-optical adjustable shooting system described in the foregoing, the shooting system includes three photosensitive chips.

In the multi-optical adjustable shooting system described in the foregoing, the shooting system includes an optical path adjustment mechanism.

In the multi-optical adjustable shooting system described in the foregoing, the shooting system includes at least two optical path adjustment mechanisms, and a quantity of the optical path adjustment mechanisms is the same as a quantity of the photosensitive chips.

Compared with the prior art, the multi-optical adjustable shooting system in the present invention achieves the following effects:

1. In the present invention, a spectroscopical module is used to separate light whose wavelengths are different, and therefore light waves that are output from the spectroscopical module are several light waves in different wavelength ranges. These light waves in the different wavelength ranges are separately received by different photosensitive chips. Therefore, each separate photosensitive chip receives a light wave whose wavelength range is relatively narrow, thereby improving definition of a photosensitive chip, and greatly improving definition of an entire picture finally formed by the shooting system.

2. In the present invention, a spectroscopical module is used to separate light whose wavelengths are different, and therefore light waves that are output from the spectroscopical module are several light waves in different wavelength ranges. These light waves in the different wavelength ranges are separately received by different photosensitive chips. Therefore, a wavelength range of an integral light wave received by multiple photosensitive chips added together is relatively wide, all wavelengths reflecting various colors can be fully utilized, and for an overall picture formed by light waves received by the multiple photosensitive chips added together, the color is truer to life and fuller.

3. In the present invention, a spectroscopical module is used to separate light whose wavelengths are different, and therefore light waves that are output from the spectroscopical module are several light waves in different wavelength ranges. These light waves in the different wavelength ranges are separately received by different photosensitive chips. Therefore, in low illuminancy, multiple photosensitive chips that receive light waves in different wavelength ranges are added together, so that a wavelength range of an available light wave becomes wide, increasing an amount of overall passed light, and thereby ensuring that an imaging picture is kept clear even when light is very dim.

### BRIEF DESCRIPTION OF THE DRAWINGS

The following further describes a specific implementation of the present invention in detail with reference to the accompanying drawing, where:

FIG. 1 is a schematic diagram of the present invention.

Descriptions about the accompanying drawing: 1. Optical lens; 2. Spectroscopical module; 3. Optical path adjustment mechanism; 4. Photosensitive chip; 5. Image processing system.

### DETAILED DESCRIPTION

The following describes an implementation of the present invention in detail with reference to the accompanying drawing.

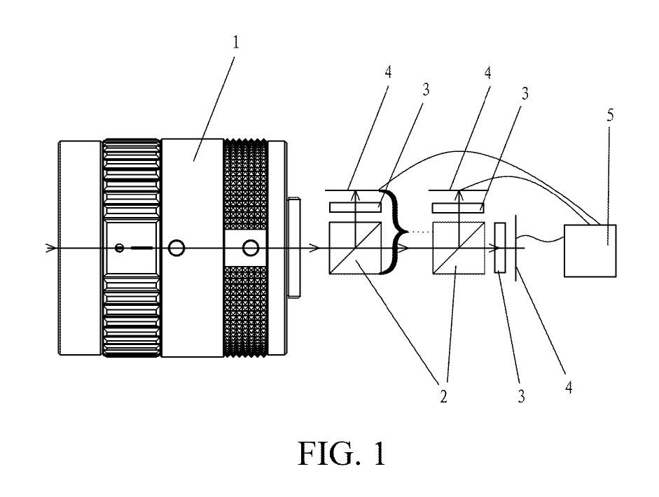

As shown in FIG. 1, a multi-optical adjustable shooting system, including an optical lens 1, where a spectroscopical module 2 that can split a light wave transmitted from the optical lens 1 into several light waves in different wavelength ranges is disposed on an imaging side of the optical lens 1; the shooting system further includes an optical path adjustment mechanism 3 configured to adjust an optical path and a photosensitive chip 4 configured to receive a light signal; and the shooting system further includes an image processing system 5 that can integrate and output light waves received by various photosensitive chips 4. The optical path adjustment mechanism 3 is disposed between the spectroscopical module 2 and the photosensitive chip 4. The optical path adjustment mechanism 3 that adjusts an optical path enables light of various wavelength ranges to form a clear image on the back photosensitive chip 4.

As shown in FIG. 1, in this embodiment, the spectroscopical module 2 includes at least one spectroscopical component, and can split a light wave transmitted from the optical lens 1 into multiple light waves in different wavelength ranges. A quantity of spectroscopical components is not specifically limited herein.

As shown in FIG. 1, in this embodiment, the shooting system includes at least one spectroscopical module 2. There may be two or more spectroscopical modules, and a quantity of the spectroscopical modules is not specifically limited herein. As shown in FIG. 1, in this embodiment, the shooting system includes at least two photosensitive chips 4. There may be three or more photosensitive chips, and a quantity of the photosensitive chips is not specifically limited herein.

As shown in FIG. 1, in this embodiment, the shooting system includes one optical path adjustment mechanism 3, that is, the optical path adjustment mechanism is disposed between only one spectroscopical module and one photosensitive chip. Certainly, the shooting system also includes at least two optical path adjustment mechanisms 3, and a quantity of the optical path adjustment mechanisms 3 is the same as the quantity of the photosensitive chips 4.

In a manner of using the spectroscopical modules 2 and matching multiple photosensitive chips 4 that receive light waves in different wavelength ranges, the spectroscopical modules 2 split light emergent from the optical lens 1 into different light waves in different wavelength ranges, optical paths for the different light are separately adjusted by the optical path adjustment mechanism 3, and then the different light separately forms a clear image on a corresponding photosensitive chip 4. The different photosensitive chips 4 separately receive light waves in particular wavelength ranges, and finally an image processing system 5 implements image restoration and reproduction, thereby improving definition of an optical system, improving color restoration, and implementing clear imaging for the shooting system even in a low illuminancy environment.

What is claimed is:

1. A multi-optical adjustable shooting system, comprising an optical lens (1), wherein a spectroscopical module (2) that can split a light wave transmitted from the optical lens (1) into several light waves in different wavelength ranges is disposed on an imaging side of the optical lens (1); the shooting system further comprises an optical path adjustment mechanism (3) configured to adjust an optical path and a photosensitive chip (4) configured to receive a light signal; the shooting system further comprises an image processing system (5) that can integrate and output light waves received by various photosensitive chips (4); and the optical path adjustment mechanism (3) is disposed between the spectroscopical module (2) and the photosensitive chip (4).

2. The multi-optical adjustable shooting system according to claim 1, wherein the spectroscopical module (2) comprises at least one spectroscopical component.

3. The multi-optical adjustable shooting system according to claim 1, wherein the shooting system comprises at least one spectroscopical module (2).

4. The multi-optical adjustable shooting system according to claim 3, wherein the shooting system comprises at least two photosensitive chips (3).

5. The multi-optical adjustable shooting system according to claim 3, wherein the shooting system comprises two spectroscopical modules (2).

6. The multi-optical adjustable shooting system according to claim 4, wherein the shooting system comprises three photosensitive chips (3).

7. The multi-optical adjustable shooting system according to claim 4, wherein the shooting system comprises one optical path adjustment mechanism (3).

8. The multi-optical adjustable shooting system according to claim 4, wherein the shooting system comprises at least two optical path adjustment mechanisms (3), and a quantity of the optical path adjustment mechanisms (3) is the same as a quantity of the photosensitive chips (4).
